(19) United States
(12) Patent Application Publication
(10) Pub. No.: US 2007/0157186 A1
(43) Pub. Date: Jul. 5, 2007

(54) High-level programming language to hardware component graph translation method

(75) Inventors: Fu-Chiung Cheng, Taipei City (TW); Shu-Ming Chang, Taipei City (TW); Jian-Yi Chen, Taipei City (TW); Kuan-Yu Yan, Taipei City (TW); Shin-Hway Yu, Taipei City (TW); Chin-Tai Chou, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/407,940

(22) Filed: Apr. 21, 2006

(30) Foreign Application Priority Data
Dec. 30, 2005 (TW) 094147587

(51) Int. Cl. G06F 9/45; G06F 9/44

(52) U.S. Cl. 717/151; 717/141; 717/162

(57) ABSTRACT

A method to hardware component graph translation process for a high-level programming language, which analyzes codes of a high-level programming language to collect class information and store the collected class information in a class information object, and generates a temporal hardware component graph to obtain corresponding public methods, parameters, return values. The public methods, parameters, return values are linked to a class start node. A method call table is generated according to both one or more in/out edges of a method call node and method information of the class information object. The one or more edges linked to the method call node are changed to a method start node according to the method call table to accordingly represent a respective method call in the codes of the high-level programming language and translate the temporal hardware component graph into a hardware component graph allowable to correspond to hardware components.

### BACKGROUND OF THE INVENTION

1. Field of the Invention

The invention relates to a method for translating a high-level programming language and, more particularly, to a high-level programming language to hardware component graph (HCG) translation method.

2. Description of Related Art

Typically hardware description languages such as VHDL, Verilog cannot directly describe the programming logic and executing the flow of a high-level programming language. Accordingly, the high-level programming language is translated into an activity diagram (AD) defined in a unified modeling language (UML). The AD is a flow description diagram that represents the programming logic and executing flow of a high-level programming language. Accordingly, the AD is not associated with physical hardware components and cannot be translated directly into a hardware description language, unless the AD is first translated into a hardware component graph (HCG).

However, when the AD is translated into the HCG, method calls of the high-level programming language cannot be presented. Namely, such a process cannot accurately translate the methods of the high-level programming language into the components of the HCQ, and further cannot translate the HCG into a typical hardware description language (HDL).

Therefore, it is desirable to provide an improved method to mitigate and/or obviate the aforementioned problems.

### SUMMARY OF THE INVENTION

The object of the invention is to provide a high-level programming language to hardware component graph (HCG) translation method, which can translate the methods of the high-level programming language into an HCG that corresponds to hardware components.

To achieve the object, there is provided a high-level programming language to hardware component graph (HCG) translation method. The high-level programming language includes one or more classes. The method includes the steps: (A) reading codes of the high-level programming language; (B) analyzing the codes in order to collect class information and store the class information collected in a class information object, and generating a temporal hardware component graph, wherein the class information object has method object, parameter object and return value object; (C) analyzing the class information object and obtaining corresponding public and private methods, parameters, return values from the temporal hardware component graph; (D) linking the public methods, parameters, return values to a class start node of the temporal hardware component graph; (E) analyzing the class information object and the temporal hardware component graph, and generating a method call table in accordance with one or more in/out edges of a method call node of the temporal hardware component graph and a method information object of the class information object; (F) using the method call table to change the one or more edges linked from the method call node to a method start node to thereby represent a respective method call in the codes of the high-level programming language and translate the temporal hardware component graph into a hardware component graph allowable to correspond to hardware components.

Other objects, advantages, and novel features of the invention will become more apparent from the following detailed description when taken in conjunction with the accompanying drawings.

### BRIEF DESCRIPTION OF THE DRAWINGS

FIG. 1 is a flowchart of a method to hardware component graph (HCG) translation process for a high-level programming language in accordance with the invention;

FIG. 2 is a schematic view of codes of a Java language for an addition in accordance with the invention;

FIG. 3 is a schematic view of a temporal hardware component graph (HCG) generated from the Java codes of FIG. 2 in accordance with the invention;

FIG. 4 is a schematic view of changed edges in accordance with the invention;

FIG. 5 is a schematic view of changed call nodes in accordance with the invention;

FIG. 6 is a schematic view of a synthesis circuit generated from Very High Speed Integrated Circuit Hardware Description Language (VHDL) codes with respect to FIG. 2 in accordance with the invention;

FIG. 7 is a schematic view of codes of a Java language for a subtraction in accordance with the invention;

FIGS. 8 and 9 are schematic views of change procedures for a hardware component graph in accordance with the invention; and

FIG. 10 is a schematic view of a synthesis circuit generating from VHDL codes with respect to FIG. 7 in accordance with the invention.

### DETAILED DESCRIPTION OF THE PREFERRED EMBODIMENT

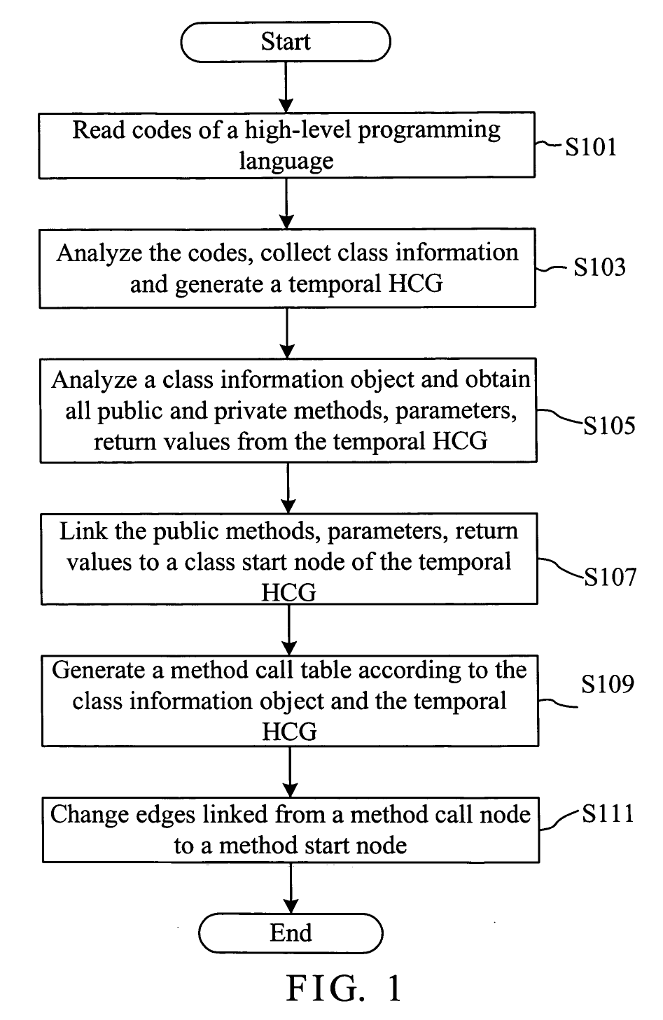

FIG. 1 is a flowchart of a high-level programming language to hardware component graph (HCG) translation method in accordance with the invention, which can translate the methods of the high-level programming language into an HCG that corresponds to hardware components. As shown in FIG. 1, step S101 reads codes of a high-level programming language. In this embodiment, the high-level programming language is a Java language, which includes one or more classes. In the Java language, the method types are of public method, private method, protected method and friend method. When a method is declared as “public”, it indicates that the method can be accessed by any method. When a method is declared as “private”, it indicates that the method can be accessed only by a member method. When a method is declared as “protected”, it indicates that the method can be accessed only by a method of a same package or a method included in a subclass inheriting from the method of the same package. When a method is declared as “friend”, it indicates that the method can be accessed only by a method of a same package. Accordingly, the protected and friend methods are grouped into a private class.

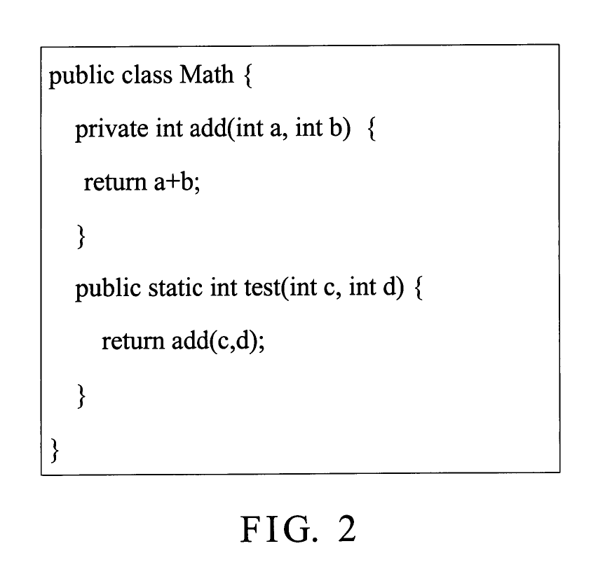

FIG. 2 is a schematic view of codes of a Java language for an addition in accordance with the invention, which includes a public class “Math” having a private method “add” and a public method “test”.

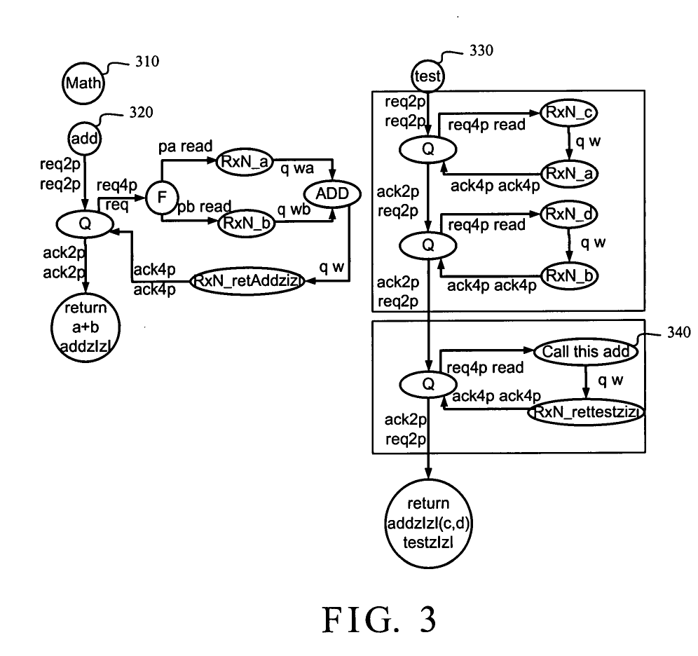

Step S103 analyzes the codes of the high-level programming language in order to collect class information of the codes of the high-level programming language and store the collected class information in a class information object, and generates a temporal HCG The class information object contains the objects of class name, method, parameter and return value. FIG. 3 is a schematic graph of a temporal HCG generated from the Java codes of FIG. 2 in accordance with the invention. As shown in FIG. 3, in the temporal HCG, the circle 310 notated “Math” corresponds to the public class “Math” of the Java codes of FIG. 2, and represents a class start node.

The circle 320 notated “add” corresponds to the private method “add” of the Java codes, and represents a method start node. The circle 330 notated “test” corresponds to the public method “test” of the Java codes, and represents another method start node. The public method “test” of the Java codes calls the private method “add”, and accordingly the temporal HCG has a node 340 notated “Call this add”.

It is known in FIG. 2 that the public method “test” calls the private method “add” to pass the parameters c and d to the parameters a and b. Accordingly, in FIG. 3, a block connected to the circle 330 shows the parameter delivery, and another block including the node 340 shows the method call of the private method “add”.

In the translation process, in addition to the temporal HCG generation, the class information in the temporal HCG is also collected. The class information contains the information of class name, method name, parameter and return value, which are stored in the class information object.

Step S105 analyzes the class information object and the temporal HCG in order to obtain public methods, parameters and return values corresponding to the temporal HCG.

Step S107 links the public methods, parameters and return values obtained in step S105 to a class start node of the temporal HCG. Accordingly, it determines which methods, parameters and return values in the temporal HCG are public, and the public methods, parameters and return values determined are linked to the class start node notated by the circle 310 or “Math” for further having corresponding hardware interfaces to input and output external signals. At linking, if there exist multiple readout or write-in, one or more multiplexers and demultiplexers are added to control the edges linked to the class start node.

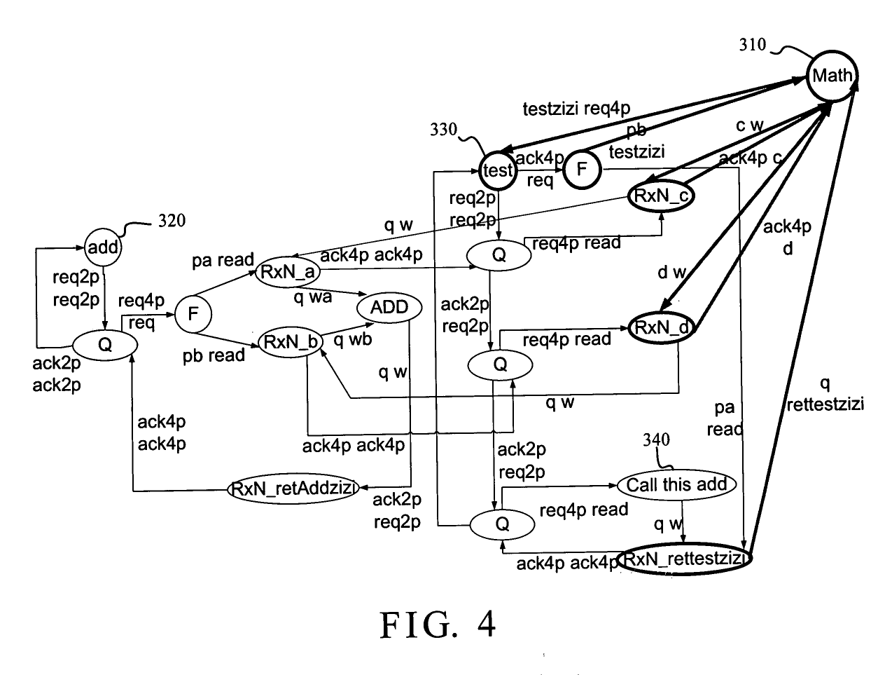

Referring again to FIG. 3, since the circle 330 or “test” corresponds to the public method “test” of the Java codes, the method start node representing the public method “test”, the parameters c and d, and the return node need to be linked to the class start node representing the circle 310 or “Math”, as shown in the bold lines of FIG. 4. Since the circle 320 or “add” corresponds to the private method “add” of the Java codes, the method start node representing the private method “add”, the parameters a and b, and the return node need not to be linked to the class start node representing the circle 310 or “Math”.

Step S109 analyzes the class information object and the temporal HCG, and generates a method call table in accordance with one or more in/out edges of a method call node of the temporal HCG and a method information object of the class information object. The information of method calls, for example, where is a method call, which method is called, which method call nodes are calling and the like, can be collected in accordance with FIG. 4 and the information in the class information object. The information collected is recorded in a method call table.

Step S111 uses the method call table to change the edges in the temporal HCG linked from the method call node to the method start node to thereby represent the method call in the codes of the high-level programming language and translate the temporal hardware component graph into a hardware component graph allowable to correspond to hardware components. At re-linking, if a method is called by multiple method call nodes, one or more multiplexers and demultiplexers are added.

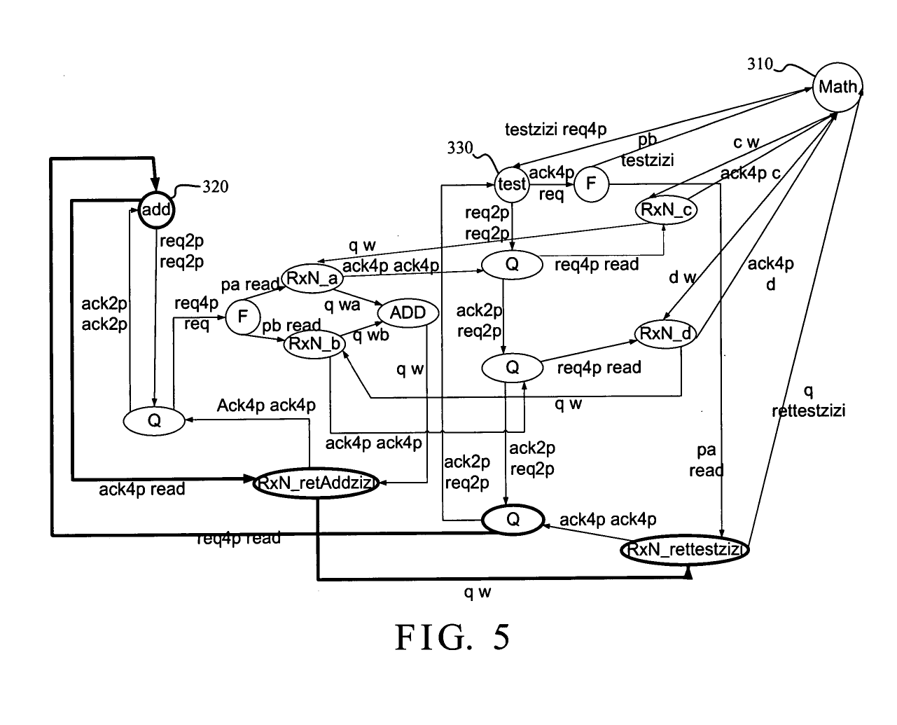

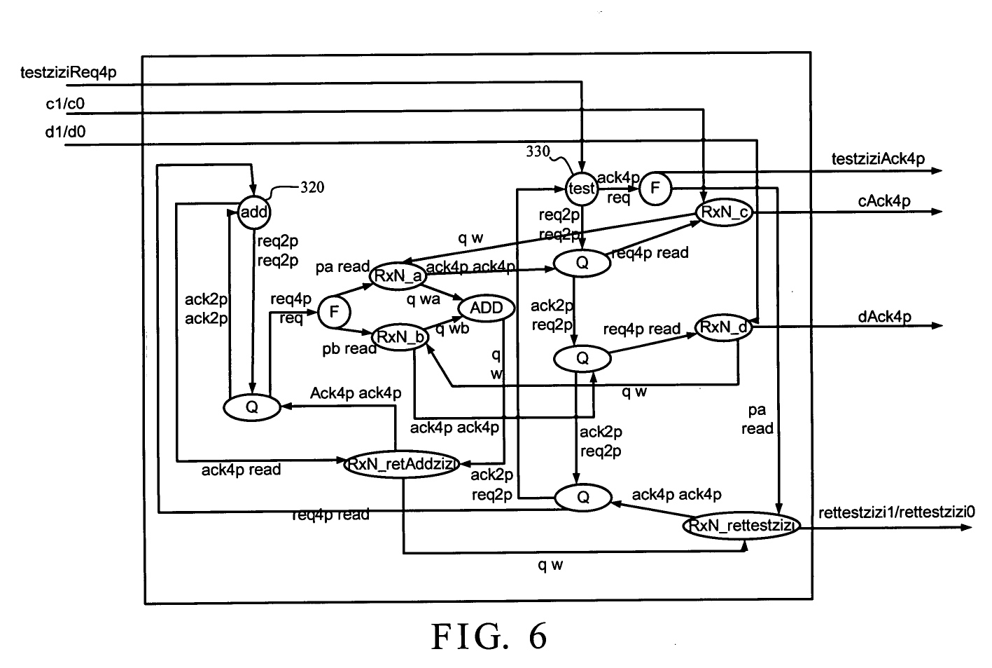

Referring again to FIGS. 4 and 5, the edge “req4p read” linked to the node 340 or “Call this add” is changed to be linked to the method start node representing the circle 320 or “add” to thereby represent calling the method “add”, and the node “RxN_retAddzizi” representing the return value of the method “add” is changed to link the node “RxN_rettestzizi” of the method “test” to thereby represent that the operational result of the method “add” is returned to the method “test”. The bold lines of FIG. 5 show a part of the method call processing in step S111. When the HCG shown in FIG. 5 is obtained, it indicates the complete method call processing for the Java codes. Accordingly, the HCG of FIG. 6 can be corresponded to the respective hardware components represented by the Very High Speed Integrated Circuit Hardware Description Language (VHDL) and translated into corresponding VHDL codes with method calls, as shown in FIG. 6, which is a synthesis circuit generated from the VHDL codes.

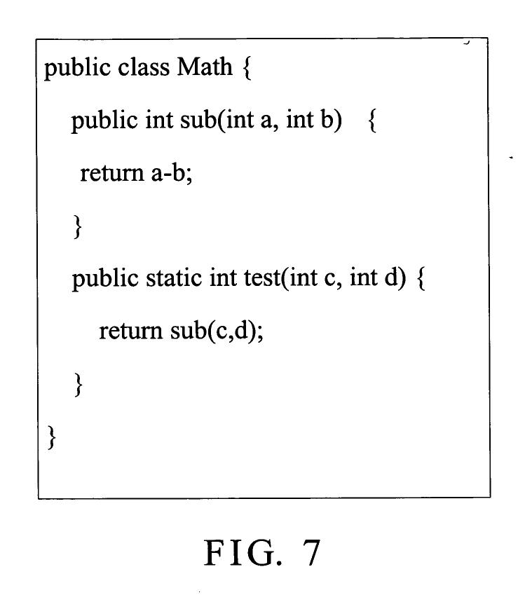

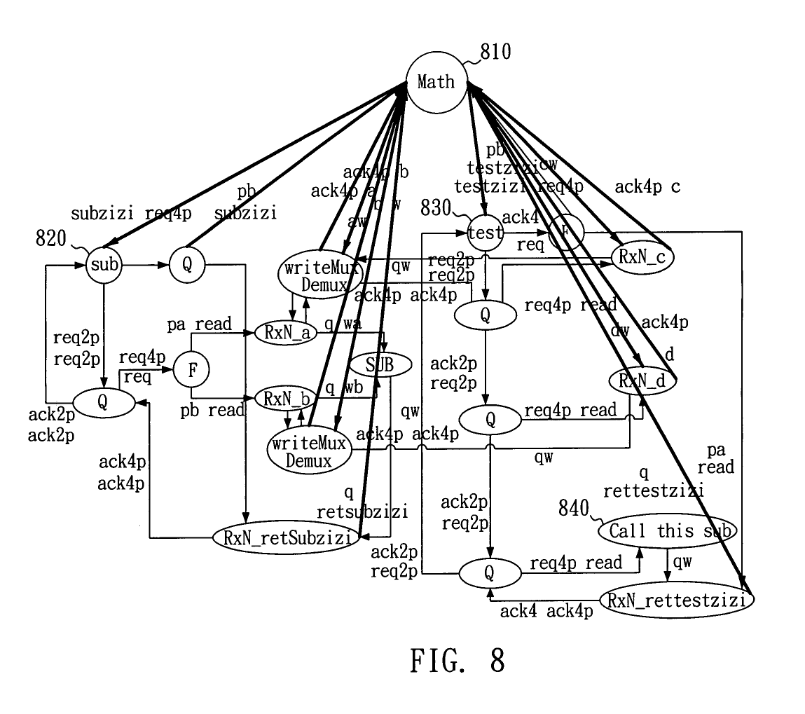

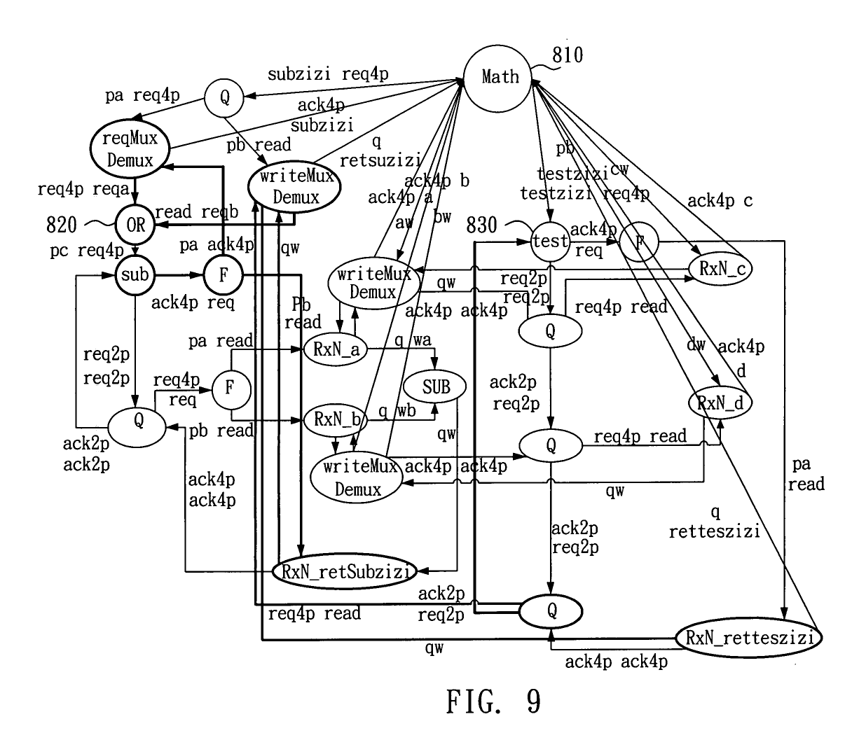

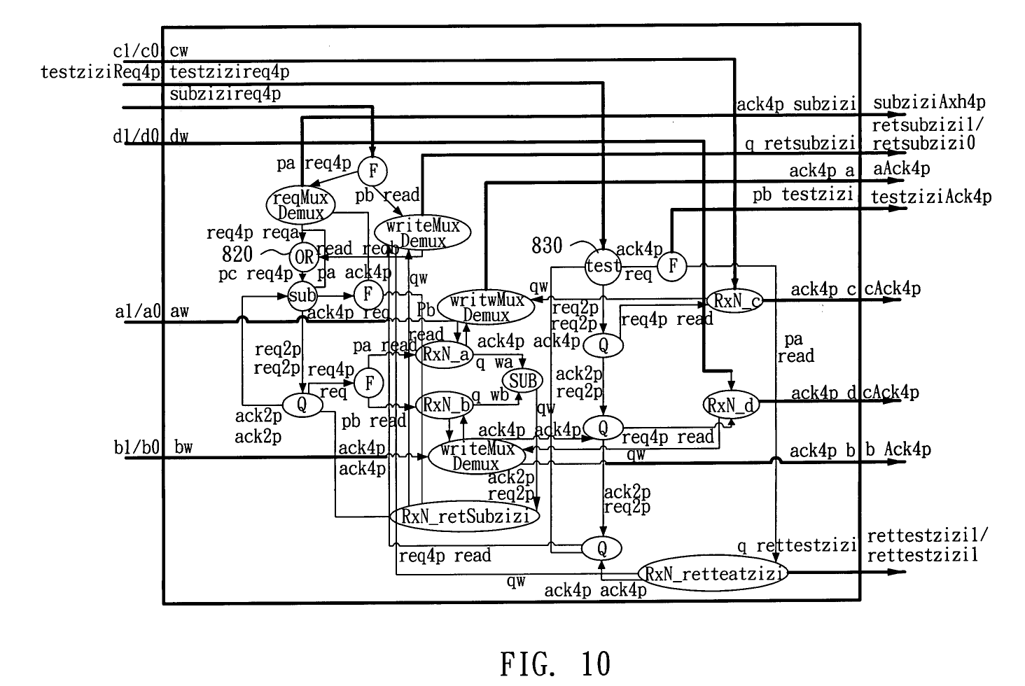

FIGS. 7 to 9 are another embodiment, which performs an subtraction and uses a public method “test” to call another public method “sub”. FIG. 10 is a synthesis circuit generated from VHDL codes with respect to FIGS. 7 to 9. In FIGS. 3-6 and 8-10, a circle “F” indicates a fork-element of the hardware components, a circle “OR” indicates an OR gate, an oval node “Q” indicates a sequential control circuit and translates a 2-phase control signal into a 4-phase signal access data, a circle “add” indicates an adder while a circle “sub” indicates a subtractor, an oval node having a name starting with “RxN”, such as “RxN_a”, “RxN_b” and so on, indicates an n-bit register, and an oval nodes “reqMuxDemux”, “writeMuxDemux” and “readMuxDemux” indicate a multiplexer and demultiplexer, which are hardware components respectively configured in accordance with a request of a control circuit, write and read to a register.

As cited, the invention uses the method call table to change one or more edges in the temporal HCG linked from a method call node to a method start node to thereby represent a respective method call in the high-level program codes, and accordingly coverts the temporal HCG into an HCG allowable to correspond to hardware components.

In view of the foregoing, it is known that the invention coverts the method calls coded by a Java language into an HCG allowable to correspond to hardware components. The HCG can correspond to the respective VHDL components and thus be easily translated into the VHDL codes, which overcomes the prior problems that the method calls coded by a high-level programming language cannot be effectively translated into an HCG so that the HCG cannot be translated into a typical HDL.

Although the present invention has been explained in relation to its preferred embodiment, it is to be understood that many other possible modifications and variations can be made without departing from the spirit and scope of the invention as hereinafter claimed.

What is claimed is:

1. A high-level programming language to hardware component graph (HCG) translation method, the high-level programming language including one or more classes, the method comprising the steps of:
(A) reading codes of the high-level programming language;
(B) analyzing the codes in order to collect class information and store the class information collected in a class information object, and generating a temporal hardware component graph, wherein the class information object has method object, parameter object and return value object;
(C) analyzing the class information object and obtaining corresponding public and private methods, parameters, return values from the temporal hardware component graph;
(D) linking the public methods, parameters, return values obtained in step (C) to a class start node of the temporal hardware component graph;
(E) analyzing the class information object and the temporal hardware component graph, and generating a method call table in accordance with one or more in/out edges of a method call node of the temporal hardware component graph and a method information object of the class information object; and
(F) using the method call table to change the one or more edges linked from the method call node to a method start node to thereby represent a respective method call in the codes of the high-level programming language and translate the temporal hardware component graph into a hardware component graph allowable to correspond to hardware components.

2. The method as claimed in claim 1, wherein step (D) uses a multiplexer and demultiplexer to control an edge linked to the class start node in linking.

3. The method as claimed in claim 1, wherein step (F) uses multiplexer and demultiplexers to control the edges linked to the method call node.

4. The method as claimed in claim 1, wherein the hardware component graph indicates a connection relation between the hardware components.

5. The method as claimed in claim 1, wherein the high-level programming language is a Java language.

6. The method as claimed in claim 5, wherein the one or more classes of the Java language comprises public method, private method, protected method and friend method.
